(19) United States
(12) Patent Application Publication
(10) Pub. No.: US 2009/0148608 A1
(43) Pub. Date: Jun. 11, 2009

(54) Coated Multipurpose Paper, Process And Composition Thereof

(75) Inventors: Lawrence N Nadeau, Fleurimont (CA); Christopher G. Belfry, Waterdown (CA); Harold S. Freeburn, Osgoode (CA); Tony Bhandari, Granby (CA); Richard Gratton, Windsor (CA)

Correspondence Address: BUCHANAN, INGERSOLL & ROONEY PC, POST OFFICE BOX 1404, ALEXANDRIA, VA, 22313-1404, US

(73) Assignee: DOMTAR, INC., Montreal (CA)

(21) Appl. No.: 11/913,551

(22) PCT Filed: Mar. 5, 2006
(86) PCT No.: PCT/CA06/00730

§ 371 Date: Oct. 31, 2008

Related U.S. Application Data
(60) Provisional application No. 60/677,820, filed on May 5, 2005.

(51) Int. Cl. B05D 3/12; B41M 5/52

(52) U.S. Cl. 427/364; 524/47; 524/52; 524/53

(57) ABSTRACT

A composition including a styrene acrylate copolymer; an organic cationic polyelectrolyte; at least one inorganic pigment; a binder; a wetting agent and a salt. Such a coated multipurpose paper is suitable for use on inkjet printers, laser printers, fax machines, copiers, offset presses and more. A process for preparing such a multicoated paper is also provided.

### TECHNICAL FIELD

The present invention relates to improvements in the field of pulp and paper industry. In particular, this invention relates to a coated multipurpose paper. Compositions used for preparing this multipurpose paper as well as processes for preparing the compositions and the multipurpose paper are also disclosed.

### BACKGROUND OF THE INVENTION

Several types of paper may be used in an office of a company for different applications. In order to avoid purchasing several types of papers for the different machines or applications they use, a coated multipurpose paper grade was developed. In fact, multipurpose papers represent an interesting solution to such a problem. However, some of the multipurpose papers proposed so far were costly and others were of poor quality and did not show good characteristics for printing purposes. Moreover, many of the proposed multipurpose papers were not suitable for use in all applications such as inkjet printers (both thermal and piezoelectric-based print heads and using dye and pigment based inks), laser printers, fax machines, copiers, offset presses and more.

Inkjet products can potentially be manufactured using coated (pigmentized surface treatment) or uncoated papers.

Uncoated grades—starch and starch based treatments are metered onto the surface of a base paper using size press application methods (uncoated freesheet products being the result).

Coated grades—anionic coating formulations are metered onto the surface (which can be untreated, pre-treated with a starch based composition or pre-coated with a coating composition). The coating layers are applied either on-line or off-line. Coated products also include specialty grades—the normal application technique for inkjet coatings in North America is to off-line coat (usually at a toll coater). The inkjet formulation generally contains highly absorptive pigments (such as silica, specialized carbonates and others), is cationic and works only for inkjet printing. Coating techniques are generally air knife, slot dye or cast coating a top coating onto paper that has been prepared for this purpose. The cost of the raw materials and process volumes is typically significant.

Although papers do exist that are uncoated and have “multipurpose” applications, there has been so far no report of a coated sheet designed for multipurpose applications.

It would therefore be highly desirable to be provided with a multipurpose paper that would overcome the above-mentioned drawbacks.

### SUMMARY OF THE INVENTION

It is an object of the present invention to provide a process for preparing a multipurpose paper which could be carried out on a large or industrial scale.

It is also an object of the present invention to provide a multipurpose paper which could be prepared according to a simple and efficient process, at low cost.

It is also an object of the present invention to provide a multipurpose paper which could be suitable for use on non-impact printing devices.

According to one aspect of the invention, there is provided a coating composition comprising a styrene acrylate copolymer, an organic cationic polyelectrolyte, at least one inorganic pigment, a binder, a salt and a wetting agent.

According to another aspect of the invention, there is provided a multipurpose paper prepared from a coating composition of the invention as defined herein.

According to another aspect of the invention, there is provided a multipurpose paper comprising a base paper and a coating derived from a coating composition of the invention as defined herein.

According to another aspect of the invention, there is provided a process for preparing a multipurpose paper comprising the steps of

a) providing a base paper;
b) preparing a coating composition of the invention as defined herein; and
c) applying, on the base paper at least one layer of the coating composition prepared in step b).

### BRIEF DESCRIPTION OF THE DRAWINGS

The invention can be better described with reference to the following drawing, wherein

FIG. 1 is a schematic cross-sectional view of one embodiment of the present invention.

### DETAILED DESCRIPTION OF THE INVENTION

The coated multipurpose paper of the present invention combines in a novel way the chemistries for toner adhesion (laser printer requirements) from the uncoated paper side with pigments used in coatings along with additional chemistries typically found in specialty applications for inkjet performance. Applicants have done this on-line (base sheet forming, application of cationic coating on one or both sides of the sheet and subsequent calendaring) thereby avoiding the extra costs inherent with off-machine coating techniques.

A method has been found by Applicants to utilize anionic styrene acrylates combined with cationic fixatives and other ingredients such that the formulation when applied properly will be a stable process resulting in a coating surface that is ink receptive for all pigment and dye based inkjet inks as well as toner receptive for all laser based electophotographic processes (non-impact printing devices). The use of low cost pigments and relative low coat weight of the process ensures a very attractively priced product.

Applicants have developed a cationic-coated grade suitable for use on all non-impact printing devices. The on-line and single coating treatment using low cost raw materials ensures an attractive price point against the alternative sheets. The combination of styrene acrylate copolymer with a wetting agent together with a cationic fixative is a very challenging combination of chemistries for a papermaker—this combination has been resolved by Applicants for good quality prints. Using low cost pigments simply adds an economical feature that Applicants expect will result in a favorable market share for the quality anticipated.

Further features and advantages of the invention will become more readily apparent from the following description of preferred embodiments as illustrated by way of examples.

It has been found that the composition of the present invention is particularly useful for the preparation of coated multipurpose papers. In particular, it has been found that this composition allowed for preparing a multipurpose paper which can be suitable for use in non-impact printing devices.

As used herein, the expression “non-impact printing devices” refers to inkjet printers (including thermal and piezoelectric-based print heads and using dye and pigment based inks), laser printers, fax machines, copiers and offset presses.

According to one aspect of the invention, there is provided a coating composition comprising a styrene acrylate copolymer, an organic cationic polyelectrolyte, at least one inorganic pigment, a binder, a salt and a wetting agent.

Pigments for use in accordance with the present invention include ground calcium carbonate products (GCC), precipitated calcium carbonate (PCC) of varying morphology, silica and alumina products. The skilled workman will appreciate that a variety of carbonates could be use as substitute to those mentioned above while performing a similar function. Preferably GCC is the pigment, and more preferably the commercial product sold under the trade name Hydracarb 60™.

Other pigments such as delaminated clays, fine clays and calcined clays. A preferred pigment is the delaminated clay from Brazil sold under the trade name Capim DG™.

Still other pigments include TiO₂, zeolites, bentonites, talc, aluminium magnesium silicates.

The total amount of pigments in the composition is 100 dry parts (the pigment dry parts being the reference amount for the other components of the composition). Therefore, when more than one pigment is used, the amount of carbonate, clay or other pigments (normally referred to as pigment package) must add up to 100 dry parts.

Styrene acrylate copolymers for use in accordance with the invention are not particularly limited. A preferred styrene acrylate copolymer is the styrene acrylate copolymer sold under the trade name Basoplast 400DS™. The styrene acrylate copolymer is present in an amount of about 2 to 15 dry parts.

Organic cationic polyelectrolyte for use in accordance with the invention are not particularly limited and include polyelyeneimine, polyamine, PolyDADMAC [Poly(diallyldimethyl ammonium chloride)] and polyamine epichlorohydrine. Preferably, the cationic polyelectrolyte is PolyDADMAC and more preferably the cationic polyelectrolyte is PolyDADMAC sold under the trade name Alcofix 269™. The organic cationic polyelectrolyte is present in an amount of about 1 to 20 dry parts.

Binders for use in accordance with the invention are not particularly limited and include starch, chemically modified starch (such as oxidized starch and ethylated starch), caseine, latex, polyvinyl alcohol and polyvinyl acetate. Preferably, the binder is an ethylated starch and more preferably the ethylated starch sold under the trade name Filmflex 70D™. The binder is present in an amount of about 1 to 25 dry parts.

Salt in accordance with the present invention include those obtained from a cation selected from the group consisting of lithium, sodium and potassium; and an anion selected from the group consisting of sulphate, nitrate, chloride, iodide, bromide and phosphate. Preferably the salt is sodium sulphate, sodium chloride or sodium nitrate. More preferably it is sodium sulphate. The salt is present in an amount of about 1 to 5 dry parts.

Wetting agents in accordance with the present invention include: diols surfactants such as acetylenic diols, ethoxylated diols, hexane diols, fluorocarbon wetting agents, silicone based surfactants, ionic wetting agents such as sodium-sulfo succinates, non-ionic wetting agents such as linear alcohols or branched carbon alcohols. Preferably the wetting agent is an acetylenic diol and more preferably an acetylenic diol that is 2,4,7,9-Tetramethyl-5-decyne-4,7-diol sold under the trade name Surfynol 104™. The wetting agent is present in an amount of about 0.05 to 1 dry part.

In one embodiment, the paper coating composition is comprising a styrene acrylate copolymer, an organic cationic polyelectrolyte that is PolyDADMAC; at least one inorganic pigment selected from a clay calcium carbonate and their mixtures thereof, a binder that is an ethylated starch, a salt selected from sodium sulphate, sodium chloride and sodium nitrate and a wetting agent that is an acetylenic diol.

Advantageously, additional components may be added to the composition depending on the needs, including the components that follow.

Lubricants for use in accordance with the present invention include ethoxylated calcium stearate, sodium, ammonium or zinc stearates and the family of glycerides. Preferably the lubricant is ethoxylated calcium stearate and more preferably the commercial product sold under the trade name Devflo 50C™. The lubricant is present in an amount of about 0.2 to 2 dry parts.

Additional pigment binders such as Casein (Pigment Binder AH™) may also advantageously be used. Other low molecular weight co-binders may be substituted for roll coaters. The additional pigment binder is present in an amount of about 0 to 2 dry parts. It will be noted that if the additional pigment binder is not included in the composition, the styrene acrylate copolymer is pre-treated so that the pH was adjusted to approximately 8 with the use of caustic soda to reduce pH shock with cationic ingredients in the coating.

Advantageously, acrylic acid/acrylamide copolymer is used as a rheology modifier. Preferably, the rheology modifier is Sterocoll BL™. The rheology modifier is present in an amount of about 0 to 0.2 dry parts.

Advantageously an optical brightner product—derivative of distyryl biphenyl compounds, preferably Tinopal SCP™, may be added to the composition. The optical brightner is present in an amount of about 0 to 4 dry parts.

In the multipurpose paper of the invention, the virgin pulp for the base paper can be a blend of softwood and hardwood to ensure favorable formation. The grade can be made as “FSC” quality (Forest Stewardship Council) such that there is a chain of custody for the pulp from the forest to the finished sheet of paper. The quality attributes that are important for the base paper include; low/no dirt, good dimensional stability (no curl issues), adequate sizing levels, and uniformity of the sheet in terms of basis weight, caliper and moisture. The coating done at the mill supplies a uniform surface that yields the properties desired for a multipurpose sheet. The coating is advantageously comprised of relatively low cost products including ground calcium carbonate pigment and/or optional delaminated clay. This allows for a relatively low cost and high brightness coated sheet, which is expected to be very competitive in all of the markets the paper is designed to perform.

The sheet can have high brightness for improved contrast and a potential wide range in basis weights. The basis range can also be of about 60 gsm to 220 gsm. Coat weight range for this C2S sheet can be from 2.5 gsm to 10 gsm per side.

According to another embodiment of the invention, there is provided a process for preparing a photographic paper comprising the steps of a) providing a base paper; b) preparing a coating composition of the invention as defined herein; and c) applying, on the base paper at least one layer of the coating composition prepared in step b).

In accordance with the present invention, the process may further comprise the steps of calendaring and/or sheeting at a toll converter or other sheeting facility.

In one embodiment, some or all the steps of the process may be conducted on-line, i.e. on a single production line without the requirement of labor to proceed from one step to the other.

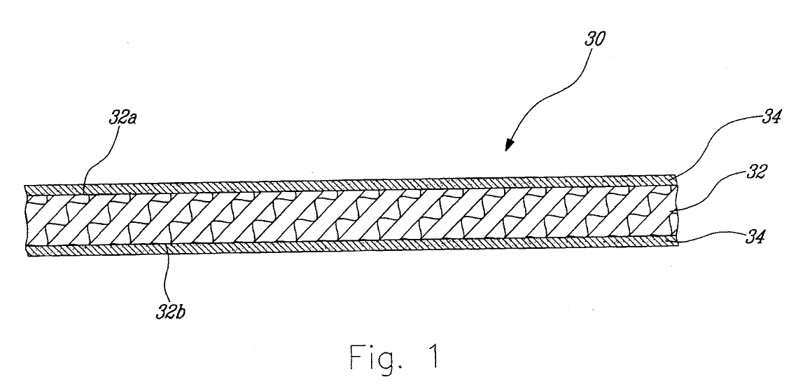

Referring to FIG. 1, a cross-sectional view of a photographic paper 30 according to one embodiment of the present invention is shown. The photographic paper includes base paper 32, and at least one layer 34 derived from the composition of the present invention. The base paper has first surface 32a and second surface 32b. The layer 34 is disposed on and covers substantially the base paper 32.

The following non-limiting examples further illustrate the invention.

### EXAMPLES

The coating composition for preparing the coated multipurpose paper was prepared by sequentially mixing the following components 1 to 12:

| | | Dry Parts |
|---|---|---|
| 1. | Hydracarb 60 ™ @ 74% solids | 30 |
| 2. | Capim DG ™ @ 70% solids | 70 |
| 3. | BF05 ™ (Polyvinyl alcohol) @ 21% solids | 4 |
| 4. | Filmflex 70D ™ @ 29.5% | 12 |
| 5. | Pigment Binder AH ™ @ 26.5% | 1.0 |
| 6. | Surfynol 104 ™ @ 50% solid | 0.3 |
| 7. | Basoplast 400DS ™ @ 25% solids | 8.0 |
| 8. | Sodium Sulphate @ 100% solids | 2.0 |
| 9. | Devflo 50C ™ @ 50% solids | 0.5 |
| 10. | Alcofix 269 ™ @ 10% solids | 8.0 |
| 11. | Sterocoll BL ™ @ 25% solids | 0.06 |
| 12. | Tinopal SCP ™ @ 100% | 1.5 |

% Solids-run tank: first run 40%/second run 39%
% Solids -makeup: 45%

Alcofix™ was diluted with city water (or equivalent) in a ratio of 4:1 (water to Alcofix) before it was added to the mixture using an injection quill into the vortex of the disperser—thus providing good mixing and avoiding high concentrations of cationic fixative which may agglomerate with anionic particles. Tinopal SCP™ was also diluted, the dilution ratio being approximately 15:1 of water to Tinopal SCP™ and water quality can be the same as used for Alcofix.

An optional operation in the process was that if the casein (known as Pigment Binder AH™), was not included in the composition, Basoplast 400DS™ was pre-treated so that the pH was adjusted to approximately 8 with the use of caustic soda to reduce pH shock with cationic ingredients in the coating.

The major steps in manufacturing the coated multipurpose sheet were as follows (in sequence);
a. Providing the base paper (prior to on-machine coating) at the paper machine in the mill. Base paper formation, moisture and sizing levels are pre-determined to optimize final coated sheet performance.
b. Preparing all coating materials as described above;
c. On-machine coating of one or both sides of the base paper;
d. On-machine soft-nip calendaring; and
e. Sheeting at a toll converter or other sheeting facility.

There are many interesting aspect with this coated multipurpose paper. All technical considerations are selected for scale-up to large tonnage industrial paper machines, coaters, soft nip calendars and ancillary equipment.

Coat weight was approximately 5 pounds per ream (total) (or approximately 10 gsm total)—that means 2.5 pounds per ream per side (or approximately 5 gsm per side).

The obtained coated multipurpose paper had the following properties:

### Grammage—90 gsm

### Thickness—4.4 mil

### Brightness—92%

Dry Time—<1 minute on all inkjet printers, all inks

In summary, the economically produced grade (since all unit operations occur on-line on the same paper machine) performs well on all known non-impact printing devices. So far the coated multipurpose paper has been tested with success on a plurality of machines including: HP 6122 ™, HPLJ8500™, HP 970Cxi™, HP LJ4300™, Canon i960™, Canon S300™, Canon S750™, Epson 870™, Epson C80™, Laser Lexmark™, Panafax U560™, Xerox DT 135™ and other office equipment.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

1. A paper coating composition comprising a styrene acrylate copolymer, an organic cationic polyelectrolyte that is PolyDADMAC; at least one inorganic pigment selected from a clay, calcium carbonate and mixtures thereof, a binder that is an ethylated starch, a salt selected from sodium sulphate, sodium chloride and sodium nitrate and a wetting agent that is an acetylenic diol.

2. A paper coating composition comprising a styrene acrylate copolymer, an organic cationic polyelectrolyte; at least one inorganic pigment, a binder, a salt and a wetting agent.

3. The composition of claim 2, wherein the organic cationic polyelectrolyte is polyelyeneimine, polyamine, PolyDADMAC [Poly(diallyldimethyl ammonium chloride)] or polyamine epichlorohydrine.

4. The composition of claim 2, wherein the organic cationic polyelectrolyte is PolyDADMAC.

5. The composition of claim 2, wherein the inorganic pigment is clay, calcium carbonate, aluminium derivatives, silica, alumina, TiO₂, zeolites, bentonites, talc, aluminium magnesium silicates or a mixture thereof.

6. The composition of claim 2, wherein the inorganic pigment is clay, calcium carbonate or mixtures thereof.

7. The composition of claim 2, wherein the inorganic pigment is ground calcium carbonate, delaminated clay or mixtures thereof.

8. The composition of claim 2, wherein the binder is starch, chemically modified starch, caseine, latex, polyvinyl alcohol or polyvinyl acetate.

9. The composition as defined in claim 8, wherein the chemically modified starch is an oxidized starch or an ethylated starch.

10. (canceled)

11. The composition of claim 2, wherein the salt is obtained from a cation selected from the group consisting of lithium, sodium and potassium; and an anion selected from the group consisting of sulphate, nitrate, chloride, iodide, bromide and phosphate.

12. The composition of claim 2, wherein the salt is sodium sulphate, sodium chloride or sodium nitrate.

13. (canceled)

14. The composition of claim 2, wherein the wetting agent is diol surfactants, fluorocarbon wetting agents, silicone based surfactants, ionic wetting agents or non-ionic wetting agents.

15. The composition of claim 14, wherein the diol surfactant is acetylenic diols, ethoxylated diols or hexane diols.

16. The composition of claim 15, wherein the ionic wetting agents is sodium-sulfo succinates.

17. The composition of claim 14, wherein the non-ionic wetting agents is linear alcohols or branched carbon alcohols.

18. The composition of claim 2, wherein the wetting agent is an acetylenic diol surfactant.

19. The composition of claim 2, further comprising lubricants.

20-21. (canceled)

22. The composition of claim 2, further comprising an acrylic acid/acrylamide copolymer.

23. The composition of claim 2, further comprising a derivative of distyryl biphenyl compounds.

24. (canceled)

25. A coated multipurpose paper comprising a base paper and a coating applied on said base paper, wherein the coating is obtained from a composition as defined in claim 1.

26. A process for preparing a multipurpose paper comprising the steps of:
a) providing a base paper;
b) preparing a coating composition as defined in claim 1; and
c) applying, on the base paper at least one layer of the coating composition prepared in step b).

27. The process as defined in claim 26, further comprising the step of calendaring a coated paper resulting from step c).

28. The process as defined in claim 26, further comprising the step of sheeting the multipurpose paper.

29. The process as defined in claim 26, wherein at least two steps are conducted on-line.

30. The process as defined in claim 26, wherein all the steps are conducted on-line.
